(19) United States
(12) Patent Application Publication
(10) Pub. No.: US 2016/0121276 A1
(43) Pub. Date: May 5, 2016

(54) DYNAMIC MIXING ASSEMBLY WITH IMPROVED BAFFLE DESIGN

(71) Applicant: Quantum Technologies, Inc., Akron, OH (US)

(72) Inventors: Peter A. Piechuta, Uniontown, OH (US); Robert E. Yant, Medina, OH (US)

(21) Appl. No.: 14/530,023

(22) Filed: Oct. 31, 2014

(51) Int. Cl. B01F 7/00; D21C 11/00; B01F 15/02

(52) U.S. Cl. CPC B01F 7/00; B01F 15/0248; B01F 15/0272; D21C 11/0057; D21C 11/0071; B01F 2215/0078

(57) ABSTRACT

A continuous dynamic mixing assembly includes a mixing chamber having an interior wall which is generally symmetrical about a central longitudinal axis. Flowable material is mixed in the mixing chamber. At least one inlet introduces the flowable material into the mixing chamber. At least one outlet discharges mixed flowable material from the mixing chamber. Axial baffles are connected to and extend along the interior wall for disrupting substantially circumferential material flow in the mixing chamber. Transverse baffles are connected to and extend from the interior wall transverse to the axis along a major dimension of the transverse baffles. A rotatable agitator includes agitator baffles extending transverse to the axis in alignment with respective transverse baffles, which forms gaps between the agitator baffles and the respective transverse baffles. The transverse baffles and the agitator baffles disrupt substantially axial fluid flow inside the mixing chamber while forcing the material through the gaps. Also featured is a method in which the mixing assembly is used.

### TECHNICAL FIELD

The present invention relates to a continuous dynamic mixing assembly for mixing liquid, solids and/or gas together for use in particular, in the paper pulping industry.

### TECHNICAL BACKGROUND

In some paper pulping processes, a solution referred to as “oxidized white liquor” is used. Oxidized white liquor is typically made by oxidizing reducing compounds found in white liquor such as sodium sulfide, sodium polysulfide and sodium thiosulfate to form an oxidized white liquor having non-reducing compounds such as sodium sulfate therein.

A stirred tank of white liquor and either air or oxygen or a combination thereof and an external heat source is a common method of commercially producing white liquor as disclosed in U.S. Pat. Nos. 5,500,085 and 5,382,322.

The oxidation reaction of sodium sulfide is exothermic and generates a significant amount of heat. A typical stirred tank process used to oxidize sodium sulfide requires additional heat input from an external source and a long residence time in the tank for the oxidation reaction to progress to a beneficial extent. Large equipment is required to hold volumes of white liquor being oxidized. In particular two stirred tanks 10 feet in diameter and 26 feet high are used. Such large tanks require a long residence time, making them inefficient and costly.

### SUMMARY OF THE DISCLOSURE

The present disclosure is directed to a continuous dynamic mixing assembly which mixes flowable material. For example, the mixing assembly can disperse and dissolve a second component of the flowable material, e.g., gas, into a first component of the flowable material, e.g., liquid or liquid-solid. It should be appreciated that any combination of solid, liquid and/or gas flowable materials can be mixed in the mixing assembly and can be considered the first material and/or the second material (e.g., liquid-liquid, liquid-solid, or liquid, solid and gas, as the first and/or second materials). The mixing assembly employs axially extending baffles and transverse baffles along with a unique agitator design including agitator baffles to enable very efficient mixing of the flowable material. Mixing alone may occur inside the mixing assembly of the disclosure. On the other hand, the mixing assembly is particularly well suited to conducting chemical reactions rapidly and at high efficiency.

Referring now to a first aspect of the present disclosure, in general a continuous dynamic mixing assembly includes the following features. A mixing chamber has an interior wall which is generally symmetrical about a central longitudinal axis and in which flowable material is mixed. At least one inlet introduces first, second or more components of flowable material (e.g., flowable liquid-solid, liquid-gas, solid, liquid and gas, or only liquid material) into the mixing chamber. At least one optional second inlet can introduce a third component of flowable material (e.g., gas) into the mixing chamber. In another aspect the solid, liquid and/or gas flowable material may be mixed prior to entering the mixing chamber. Axial baffles are connected to and extend along the interior wall for disrupting substantially circumferential material flow in the mixing chamber. Transverse baffles are connected to and have a major dimension that extends from the interior wall transverse to the axis. A rotatable agitator includes agitator baffles extending transverse to the axis in alignment with respective transverse baffles. The agitator baffles and the transverse baffles are constructed and arranged to form gaps between them and to disrupt substantially axial material flow while forcing the flowable material through the gaps. At least one outlet discharges mixed flowable material from the mixing chamber. Reference to transverse to the axis in this disclosure does not require a perpendicular orientation relative to the axis.

More specific features of this first aspect will now be described. The mixing chamber can be cylindrical. The at least one inlet can be constructed and arranged to introduce the flowable material tangentially into the mixing chamber. The at least one outlet can be constructed and arranged to permit the mixed flowable material to travel tangentially out of the mixing chamber. The at least one second inlet can include a plurality of inlets disposed along a length of the mixing chamber (e.g., for feeding gas into the mixing chamber). A venturi can be located upstream of the at least one inlet for mixing a second component of the first material with a first component of the first material before passing through the at least one inlet into the mixing chamber. The mixing chamber can be arranged to extend substantially horizontally in all aspects of the disclosure.

Regarding further specific features of the first aspect, the agitator can include twisted blades. Another feature is that the agitator can include a central shaft, a cylindrical central portion fastened to and extending around the shaft; and the blades are twisted along the central portion.

Still further, the assembly can include at least two of the transverse baffles and at least two of the agitator baffles; wherein the transverse baffles and the agitator baffles partition the mixing chamber into at least three axial segments. For example, at least three of the blades and at least two of the axial baffles can be disposed in each axial segment and are circumferentially offset from corresponding blades and corresponding axial baffles, respectively, in an adjacent axial segment. In particular, four or more blades and four or more axial baffles can be located in each segment.

In another feature the agitator can include flat faces and straight blades extending diagonally along the flat faces in a direction of a length of said agitator; the blades have arcuate portions.

In another specific feature, the axial baffles extend from the interior wall of the mixing chamber inwardly toward the agitator that is located centrally in the mixing chamber. In this design, both sides of the axial baffles are exposed to the flowable material.

In another specific feature, each of the axial baffles includes a baffle assembly having a plate and support legs. For example, the plate can extend substantially parallel to a tangent to an inner (e.g., circular) periphery of the transverse baffles and the support legs fasten the plate to the interior wall of the mixing chamber. The plate has only one surface that contacts the flowable material inside the mixing chamber. For example, the plate of one of the baffle assemblies can be diametrically opposed from the plate of another of the baffle assemblies in one segment.

It should be appreciated that any of the above specific features of the first aspect of this disclosure may be combined in any combination. In addition, various features from the Detailed Disclosure below may used in the first aspect of this disclosure and can be combined with any of the above specific features in any combination.

A second aspect of the present disclosure features a continuous dynamic mixing assembly including the following more specific features. The blades of said rotatable agitator are helical shaped. The rotatable agitator includes at least two agitator baffles extending substantially transverse to the axis disposed in alignment with respective transverse baffles. Each of the agitator baffles has a substantially circular outer peripheral edge and each of the transverse baffles is annular and includes a substantially circular inner peripheral opening. One of the agitator baffles is disposed inside the opening of one of the transverse baffles. The gaps are substantially annular.

Referring to specific features of the second aspect, a shaft of the agitator extends from ends of the mixing chamber and a seal and bearing is disposed around each end of the shaft. At least one set of the seals and bearings, for example, at the outlet end of the mixing chamber, is adapted to move upon a temperature increase in the mixing chamber that causes a difference in thermal expansion between the mixing chamber and the shaft.

It should be appreciated that various features from the Detailed Disclosure below can be used in the second aspect in any combination and can be combined with the above specific feature of the first and/or second aspect of this disclosure in any combination.

A third aspect of the present disclosure features a method of mixing flowable material using the mixing assembly of the first aspect described above, including the following steps. The flowable material (e.g., liquid, liquid-gas, and/or liquid-solid-gas) is directed through the at least one inlet into the mixing chamber. Another (e.g., third) component of the flowable material (e.g., gas or possibly low density liquid) is directed through the at least one second inlet into the mixing chamber. The agitator is rotated inside the mixing chamber. Substantially circumferential material flow is disrupted in the mixing chamber with the axial baffles. Substantially axial material flow is disrupted with the transverse baffles and the agitator baffles. The flowable material inside the mixing chamber is forced to travel through the gaps between the transverse baffles and the agitator baffles. Mixing alone can occur inside the mixing chamber. In another aspect, mixing and a reaction can occur inside the mixing chamber. The flowable material is removed from the mixing chamber though the at least one outlet.

It should be appreciated that when a reaction occurs, the mixed material that flows from the mixing chamber out the outlet may or may not include the first and second materials, and can include at least one reaction product of these materials. For example, white liquor may be the first component of the flowable material, oxygen-containing gas may be the second component of the flowable material and the mixed flowable material that leaves the mixing chamber through the outlet is predominantly oxidized white liquor with small amounts of unreacted white liquor and unreacted oxygen-containing gas, or nearly completely oxidized white liquor.

Referring to specific features of the third aspect of the present disclosure, the first component of the flowable material can comprise a liquor obtained in a paper mill. The first component of the flowable material can be selected from the group consisting of white liquor, black liquor, green liquor, animal waste, paint and combinations thereof. The second component of the flowable material can be a gas selected from the group consisting of O₂, CO₂, O₃, NO, N₂, other inert gas, steam and combinations thereof. The first component of the flowable material can comprise oxidizable compounds. The first component of the flowable material can be continuously conveyed into the mixing chamber.

The components of the flowable material may be combined together before entering the at least one inlet of the mixing chamber or can be separately added to the mixing chamber (e.g., at least one component of the flowable material entering the at least one inlet and the gas component of the flowable material entering the at least one second inlet).

Regarding further specific features, the at least one inlet can be constructed and arranged to introduce the flowable material tangentially into the mixing chamber. The at least one outlet can be constructed and arranged to permit the mixed flowable material to travel tangentially out of the mixing chamber. The blades can have a constant height from the central portion and can be twisted along the central portion. As a further feature at least two of the transverse baffles and at least two of the agitator baffles can partition the mixing chamber into at least three axial segments. Still further, the agitator can include at least four blades and at least four axial baffles in each axial segment disposed around the central portion of the agitator.

In another aspect, the horsepower/volume of the mixing assembly ranges from 4/1-6/1, where horsepower is the power at which the motor is rated and volume is a volume of flowable material (e.g., a liquid or a liquid including suspended solids) in the mixing chamber in gallons. In another aspect, mass transfer of the mixing assembly ranges from 0.1694-12.64 gram mole O₂/gallon of flowable material reaction volume flowing through the mixing chamber, and in particular from 0.632-12.64 gram mole O₂/gallon. Further, the rotating speed of the agitator is at least 60 rpm and can range, for example, from 60-120 rpm for larger sized apparatus. Smaller sized apparatuses may employ a rotation speed of the agitator from 60 rpm up to 3600 rpm.

Still further, each of the blades can have a constant height along an entire length of the blade and is twisted along the central portion. One suitable blade twist may be referred to as a helical twist. At least three-six blades can be disposed around the circumference of the agitator central portion or shaft in each axial segment. The blades in one segment are axially separated from (and for example, circumferentially offset from) the blades in the adjacent axial segment by an agitator baffle.

The dynamic mixing assembly of the present disclosure enables the efficient dispersion and dissolution of different materials into one another. In particular, the mixing assembly enables gas to be inlet into the mixing chamber for oxidizing the first material. The present disclosure enables the oxidation of a white liquor liquid as the first component of the flowable material and oxygen-containing gas as the second component of the flowable material, to occur at least about 200 times faster than in a conventional tank reactor system. These and other advantages are obtained by the combination of the design of the axial and transverse baffles, and by the design of the agitator baffles. The agitator blade design also favorably contributes to the rapid and efficient mixing in the mixing assembly of this disclosure.

While not wanting to be bound by theory, this much higher reaction rate is believed to occur as a result of very high temperature conditions in a reaction zone inside the mixing chamber. While not wanting to be bound by theory, cavitation or implosion of gas bubbles in a reaction zone inside the mixing chamber, is believed to release incredibly high heat at point locations inside the mixing chamber, which is believed to cause the dramatic increase in mixing and/or mixing and reaction rate.

The design of the agitator blades, agitator baffles, and axial and transverse baffles of the mixing chamber offer numerous advantages and serve a plurality of purposes. The baffle systems disrupt axial and circumferential fluid flow and enable efficient mixing. Referring to axial material flow in this disclosure means fluid flow that occurs substantially along the longitudinal axis of the agitator. It should be realized that the fluid flow inside the mixing chamber of this disclosure is complex and reference to disrupting or inhibiting axial fluid flow, circumferential fluid flow and axial fluid flow adjacent the agitator are only intended to illustrate effects of the baffles inside the mixing chamber without unduly limiting the disclosed mixing assembly. Referring to circumferential fluid flow in this disclosure means non-axial fluid flow near the interior wall of the mixing chamber. It should also be appreciated that fluid flow as used herein is used in a general sense without regard to the specific composition of the fluid (e.g., fluid may include solid, liquid and/or gas).

A space between the arcuate blade tip and the adjacent axial baffle passed by the blade tip at their closest point, exists as the blades pass each of the axial baffles. The arcuate or twisted blade design on the central cylindrical portion of the agitator enables the blades to utilize a sweeping action relative to the inward edges of the axial baffles. Since the blades are arcuate or twisted, only a small portion of a blade is closest to an adjacent axial baffle at one time forming the predetermined space. This closest portion of the blade is referred to as a blade tip. As the agitator rotates, this arcuate blade tip progresses in one direction along a length of the axial baffle. Once the blade tip of that particular blade reaches an end of a particular segment, the next circumferentially offset blade in that segment now has its closest portion or blade tip at a start of that axial baffle in that segment. For example, when viewed from a cross-sectional end view, the four blades in each axial segment each twist for a span of about 90 degrees. The blades in the downstream segment are circumferentially offset in a cross-sectional end view such that the starting location of each of the blades in the downstream axial segment is between the end point of blades in the upstream axial segment. For example, the axial baffles of a downstream axial segment circumferentially offset from the axial baffles of the adjacent upstream axial segment in a cross-sectional end view. The sweeping of the blades past the axial baffles causes a unique mixing action and further lessens mixing power consumption. Generally at least one point on at least one blade edge (blade tip) is separated from at least one point on at least one axial baffle edge by the predetermined space, which maximizes mixing efficiency. The flow in the mixing chamber can be increased or retarded based upon the speed and rotational direction of the agitator, in view of its twisted blade orientation.

While not wanting to be bound by theory, in one aspect the mixing assembly is believed to enable the formation of three material zones, an inner, primarily gas zone around and near the agitator, a liquid (including liquid-solid) zone radially outward from the gas zone and near the interior wall of the mixing chamber, and a reaction zone between the liquid and gas zones (in space S) and extending outward to the interior wall, having a combination of liquid and gas and possibly solid.

Further advantages are that the transverse baffles and agitator baffles aligned with them can advantageously partition the mixing chamber into at least two axial segments and in particular, three or more axial segments. When liquid contacts the transverse baffles it is directed inwardly toward the agitator. In addition, when gas traveling along the agitator contacts an agitator baffle, it is directed outwardly, impeding gas from passing through the mixing chamber unreacted. The present mixing assembly is well suited for conducting chemical reactions, such as oxidation of liquids, in view of its thorough liquid/gas mixing. The generally radial space between the agitator blade tips and axial baffles, as well as the gap between the agitator baffles and the transverse baffles, can be adjusted which enables the reaction zone size, and thus the residence time of the liquid, to be selectively adjusted. Unique mixing and chemical reaction occur in the mixing chamber according to this disclosure, among other things, as a result of the relative construction and arrangement of the gaps between the agitator baffles and the transverse baffles. Despite each of these gaps having a relatively small area, all flowable material inside the mixing chamber, in some cases including solids, needs to pass through these gaps. As a result, a complex material flow is believed to occur inside the mixing chamber.

The mixing assembly of the present disclosure may be applied in mixing a wide variety of materials and two or three-phase mixtures. Some examples include the injection of a gas into the mixing chamber which already contains a liquid or liquid/solid material as a first material or injecting liquid and gas into the mixing chamber for reaction and mixing. In this disclosure a solid suspended in a liquid may be considered to contain liquid and solid phases. When liquids include fine suspended solids or dissolved solids they can be referred to as a liquid herein. Various types and combinations of flowable materials may be mixed and reacted in the reactor mixer.

The mixing assembly of the present disclosure is particularly well suited for conducting chemical reactions which involve the mixing of gas into a material for subsequent dilution and chemical reaction. Solutions which contain oxidizable compounds, for example, paper pulp mill white liquor, black liquor, green liquor, and combinations thereof, and similar solutions are particularly suitable for oxidation reactions within the mixing assembly of the present disclosure. U.S. patent application Ser. No. 08/893,601 entitled “Method of Oxidizing White and Black Liquor,” filed Jul. 14, 1997, is incorporated herein by reference in its entirety, especially with regard to materials that may be oxidized in accordance with the present invention and an overall system for producing a solution of oxidized liquor in which the present reactor mixer may be used. When an oxygen-containing gas is admitted into the mixing chamber and an oxidizable liquor solution is flowing through the mixing chamber, favorable oxidation reactions occur in relatively short time intervals, using relatively little energy. These and other advantages arise from the interplay of the baffling system and the unique agitator design causing a high degree of mixing.

The mixing assembly may be used on innumerable systems, many of which have been difficult to thoroughly mix. Paint can be mixed in the mixing assembly. For example, iron oxide and fluid, have been mixed in the mixing assembly. Even though iron oxide can be difficult to keep suspended, after mixing in the mixing assembly of this disclosure the iron oxide stayed in suspension much longer than usual. Titanium dioxide fluid may be mixed in the mixing assembly. Calcium hydroxide and magnesium hydroxide may be carbonated by mixing with CO₂ gas in the mixing assembly of the disclosure. Nanosized particles may be mixed in liquid and maintained longer in suspension. In all aspects of the disclosure adding inert gas alone or to other gas in the mixing chamber may assist in mixing. Ozone and/or O₂ gas may be mixed with animal waste in the mixing assembly for killing microbes and resulting in a reduction in biochemical oxygen demand (BOD).

Many additional features, advantages and a fuller understanding of the disclosure will be had from the accompanying drawings and the detailed description that follows.

### BRIEF DESCRIPTION OF THE DRAWINGS

FIG. 1A is a top plan view of the mixing assembly of this disclosure; FIG. 1B is a front view thereof; FIG. 1C is a cross-sectional view taken along lines 1C-1C in FIG. 1A; FIG. 1D is a left side view of the mixing assembly of FIG. 1;

FIG. 2A is a cross-sectional front view of the mixing assembly, without the axial baffles; FIG. 2B is a view of the agitator of FIG. 2A; FIG. 2C is a view taken along lines 2C-2C of FIG. 2A; FIG. 2D is a front view of an agitator of a second design according to this disclosure; FIG. 2E is an enlarged perspective view thereof; FIG. 2F is an end view thereof and FIG. 2G is an enlarged front view thereof;

FIG. 3A is a side view of the mixing assembly showing only the axial baffles of one design; FIG. 3B is a cross-sectional view as seen from lines 3B-3B of FIG. 3A; FIG. 3C is a cross-sectional view as seen along lines 3C-3C in FIG. 3A; and FIG. 3D is an enlarged cross-sectional view of the mixing chamber, baffles and agitator; and

FIG. 4A is a side view of the mixing assembly including a different design of axial baffles; FIG. 4B is a cross-sectional view taken from lines 4B-4B of FIG. 4A; FIG. 4C is a cross-sectional view taken from lines 4C-4C of FIG. 4A; and FIG. 4D is an enlarged cross-sectional view of the mixing chamber, baffles and agitator, including possible locations of possible components of flowable material in the mixing chamber; and

FIG. 5 shows a schematic representation of two mixing assemblies in series used in the method of this disclosure.

The drawings included as a part of this specification are intended to be illustrative of preferred embodiments of the invention and should in no way be considered a limitation on the scope of the invention.

### DETAILED DESCRIPTION OF THE DISCLOSURE

Referring now to the drawings, a mixing assembly 10 permits mixing of flowable material: solid, liquid and/or gas. This flows into the mixing assembly through the at least one inlet and the optional at least one second inlet in any combination or selection of types of materials. The flowable material can have many component variations, for example: all liquid; two or more liquids with or without gas; liquid and suspended solids with or without gas; liquid with dissolved solids with or without gas; or liquid with suspended or dissolved solids and/or gas, for example.

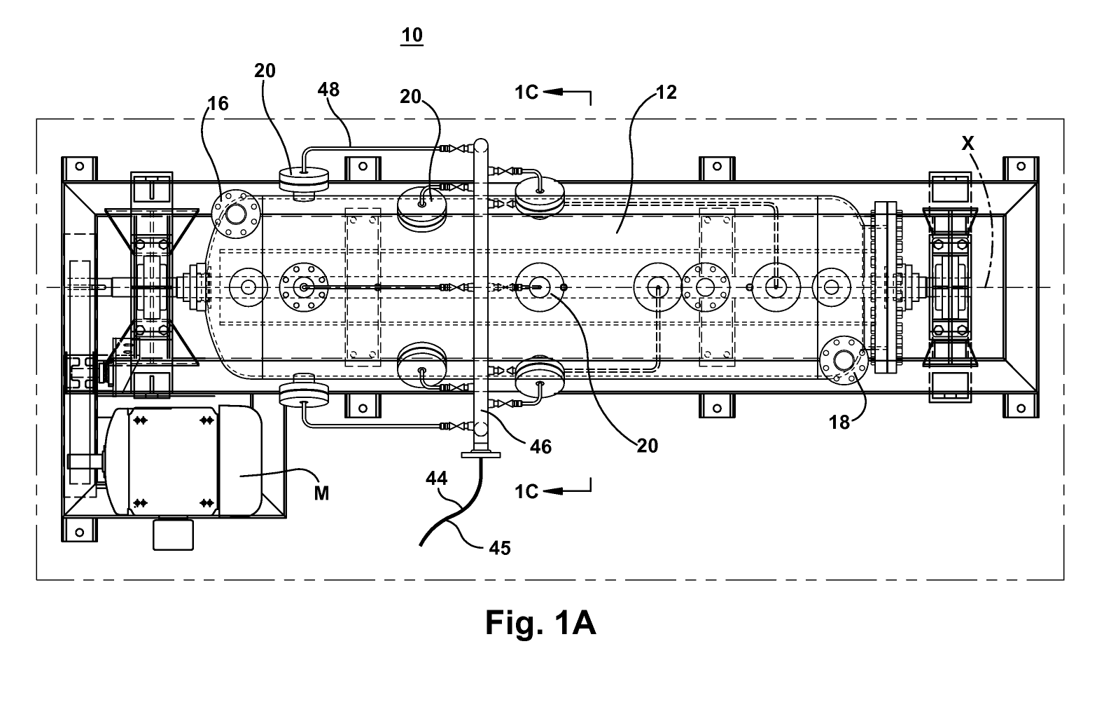

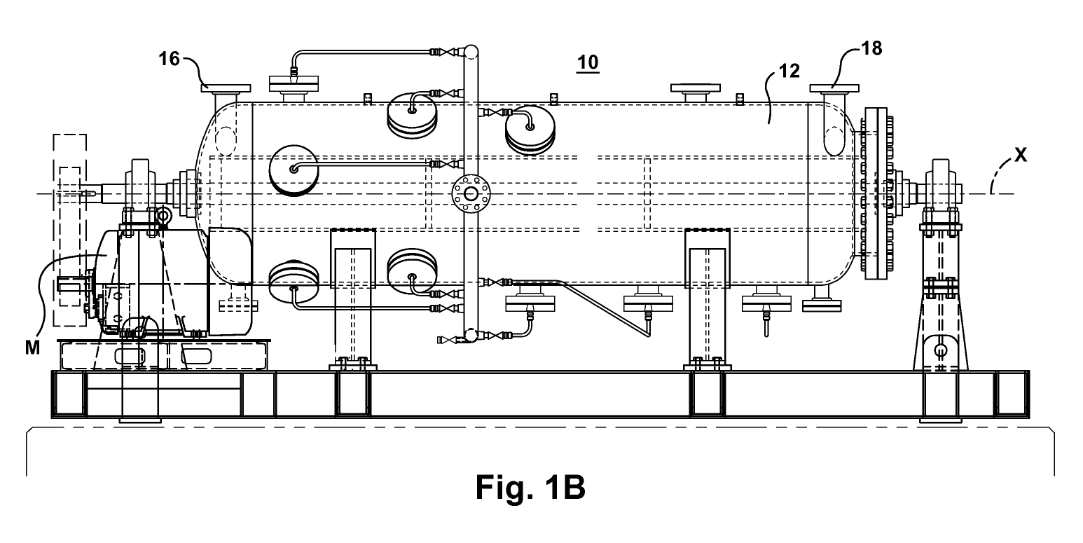

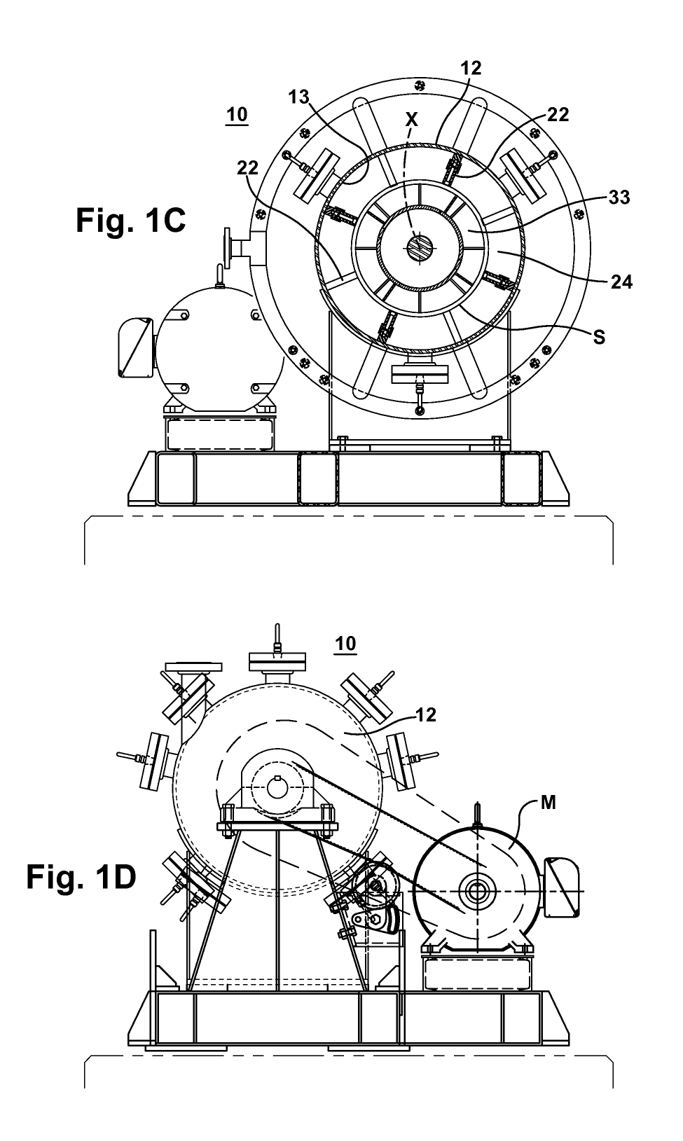

The mixing assembly comprises a generally cylindrical mixing chamber 12 having an interior wall 13. The mixing chamber is substantially symmetrical about a central longitudinal axis X (FIG. 1). The mixing chamber can be substantially horizontally extending. At least one inlet 16 is connected to the mixing chamber 12 through which the flowable material is introduced into the mixing chamber 12. At least one optional second inlet 20 is connected to the mixing chamber and introduces a third component of the flowable material into the mixing chamber (e.g., gas). At least one outlet 18 is connected to the mixing chamber 12 and discharges mixed flowable material from the mixing chamber 12. In many cases, at least one reaction also takes place inside the mixing chamber upon mixing the first component (optional second component) and the third gas component together inside the mixing chamber. This produces at least one reaction product. The at least one optional second inlet may include gas inlets 20 (some of which are labeled in FIG. 1A) disposed at a plurality of locations around the mixing chamber for introducing gas as the second component into the mixing chamber.

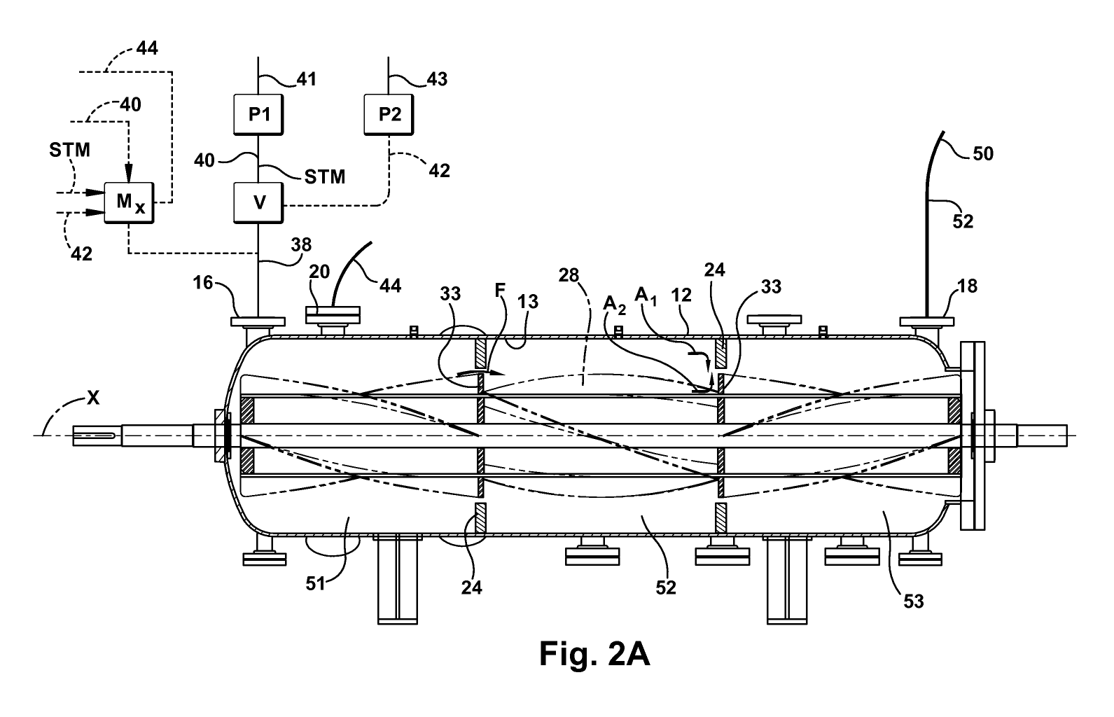

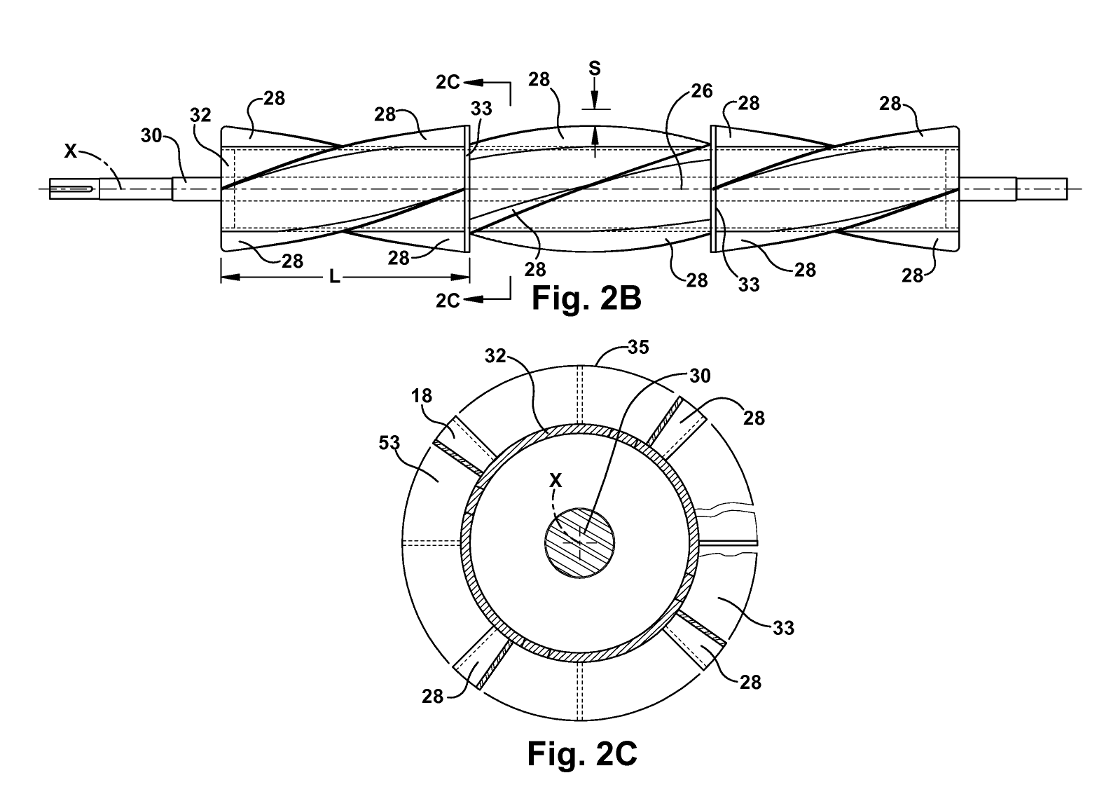

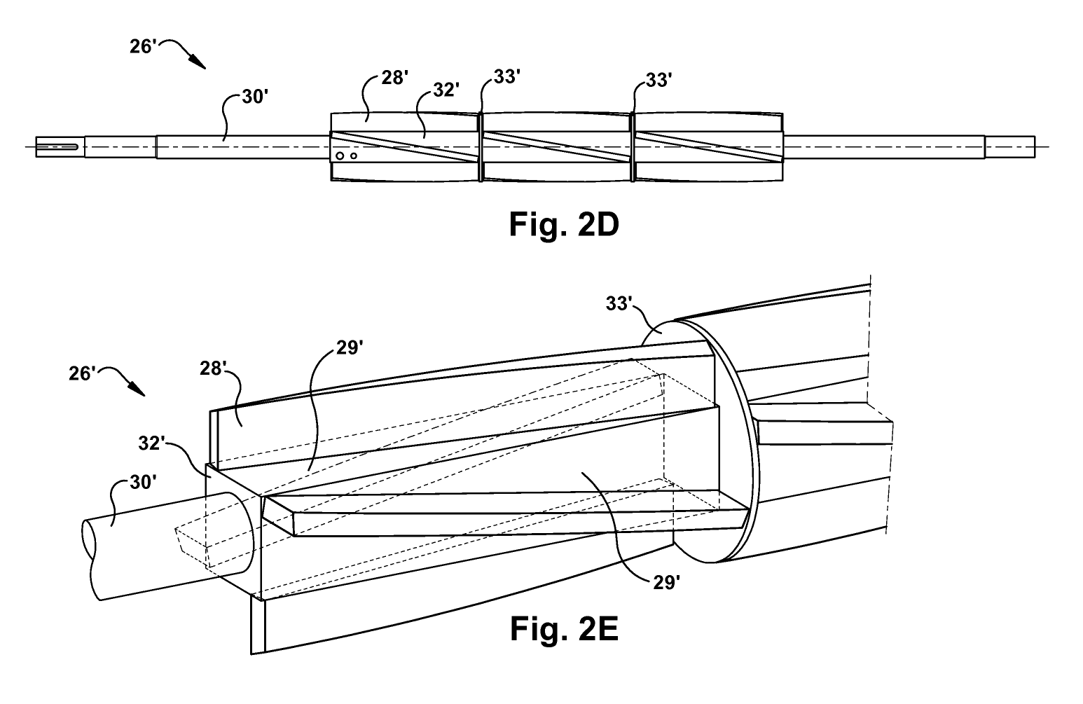

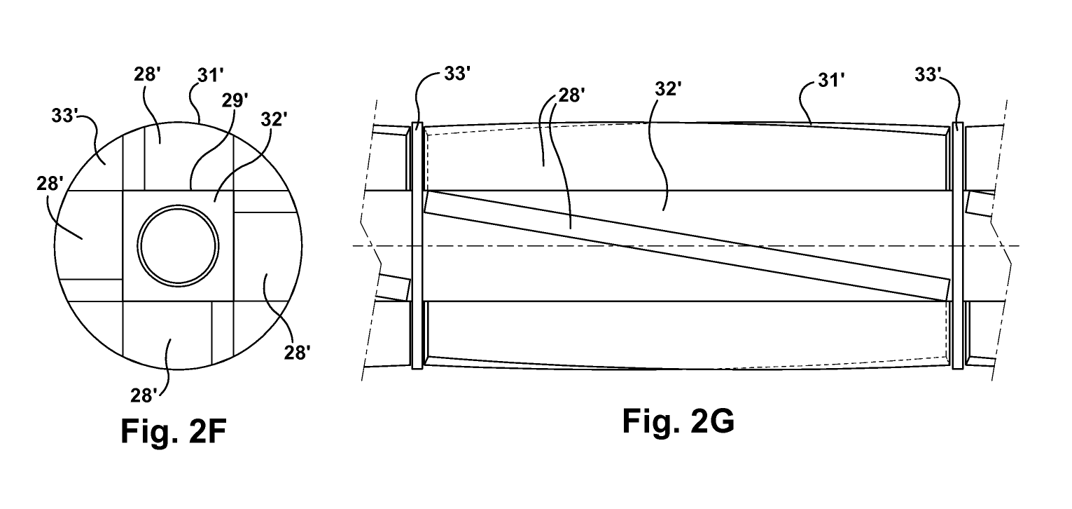

Axial baffles 22 of a first design (FIG. 1C) extend along their length (long dimension) along the axis. Transverse baffles 24 extend transverse to the axis X, for example, perpendicular to the axis X, along their major dimension. Referring to FIGS. 2A-C, a rotatable agitator 26 includes multiple blades 28. In one design, the agitator 26 includes a shaft 30 and a central hub portion 32 welded to the shaft that extends in the mixing chamber along the axis X. For example, the blades 28 each have a twisted orientation on the central portion 32 of the agitator. The agitator may be referred to as having helical blades, or being a helical rotor, rotary screw or the like (such as the rotary devices used in screw compressors). For one example, see http://www.gearandrack.com/worm_worm_gears/helical_rotors.html. Other variations of the agitator may be employed. The agitator may include other features besides blades without departing from the spirit and scope of the present disclosure, for example, lobes, threads, or the like.

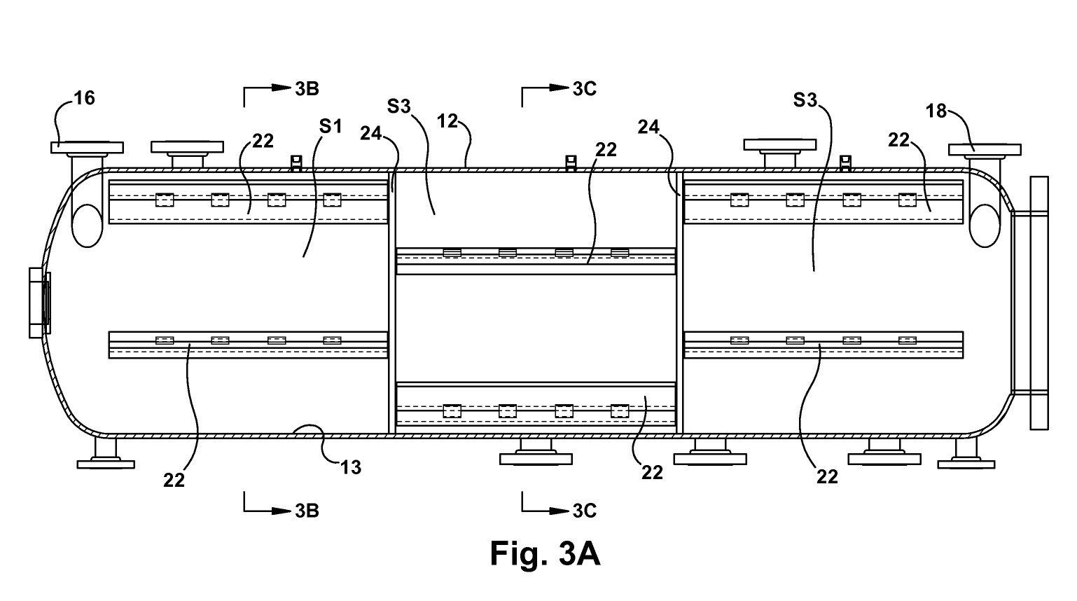

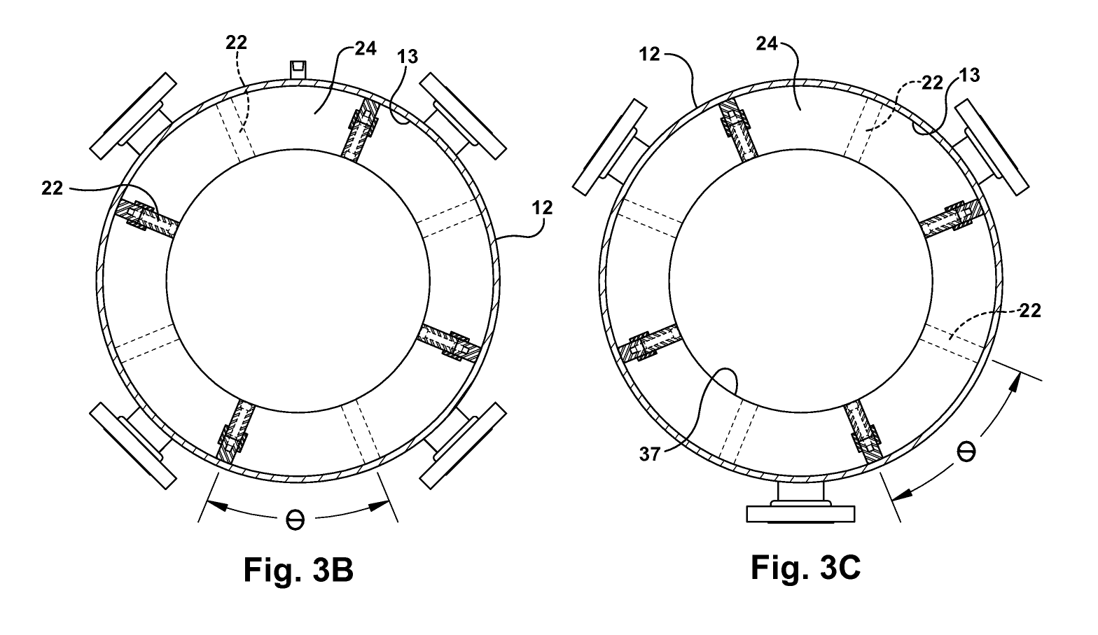

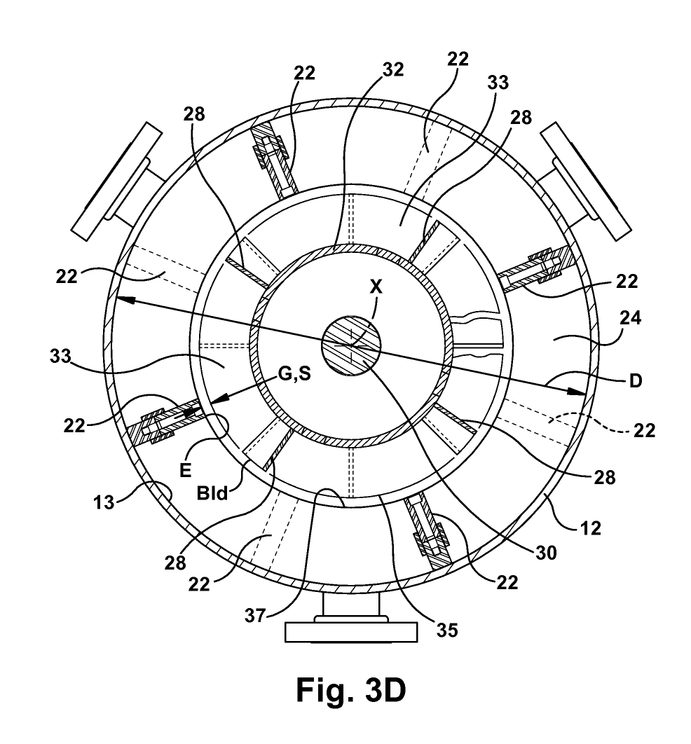

The agitator 26 includes agitator baffles 33 (FIGS. 2A-C) that extend transverse to the axis X along their major dimension and are in alignment with respective transverse baffles 24 of the mixing chamber. More specifically, the transverse baffles 24 and the agitator baffles 33 are constructed and arranged to partition the mixing chamber into at least three axial segments (e.g., S1, S2 and S3 in FIG. 3A). The agitator baffles 33 may have a circular outer edge or profile 35 (FIG. 2C) while the transverse baffles 24 may be annular and have a circular inner opening defined by an inner opening 37 (FIG. 3C). One of the agitator baffles 33 is disposed in the circular opening of a respective one of the transverse baffles. Therefore, the gaps G (FIG. 3D) between the agitator baffles 33 and the transverse baffles 24 can be annular and are relatively small compared to the internal diameter D of the mixing chamber (e.g., ⅝ inch gap and a mixing chamber having an outer diameter of 2.5 feet). However, gap size G is not dependent on the mixing chamber diameter.

The agitator can have twisted blades 28 in each axial segment around a circumference of the central portion of the agitator (FIGS. 2A, 2B). The twist may be referred to as a helical screw twist and the agitator shaft, central portion and blades can be similar to or the same as that of U.S. Pat. No. 6,036,355, which is directed to a previous mixing assembly design by Quantum Technologies and is incorporated herein by reference in its entirety.

In another variation (FIGS. 2D-2G), the agitator 26′ includes flat faces 29′ and straight blades 28′ extend diagonally along the faces in a direction of a length of the agitator. Like reference numerals are used to show similar parts throughout the several views. The blades can include outer arcuate outer surfaces 31′ (FIG. 2F and FIG. 2G). The agitator 26′ also includes agitator baffles 33′. This also may achieve movable venturis in the space S discussed in more detail below and function similar to the agitator with twisted blades described in this disclosure. This agitator may be used in all aspects of the mixing assembly of this disclosure.

The blades 28 on the present agitator in each segment are axially spaced from the blades in another segment. All of the fluid (including gas, liquid and/or any solids) in the mixing chamber must pass through the relatively small gaps G, which introduces unique fluid flow inside the mixing chamber, and improved mixing and reaction of the liquid, solid and/or gas.

While not wanting to be bound by theory, it is believed that forcing gas bubbles and liquid in the space S (FIG. 1C) between the axial baffles 22 and outer peripheral edge of the agitator blades 28 causes cavitation or implosion of the bubbles at very unusual conditions of changing pressure and very high temperature, which contributes to the extremely efficient and rapid mixing inside the dynamic mixing assembly. This space S is shown as a representation in FIG. 2B where a blade tip of a twisted blade is closest to the axial baffle, for purposes of illustration only, rather than the exact location of the axial baffle in the mixing chamber. The space S exists along the length of the axial baffles in each segment. As shown in FIG. 3D the space S and gap G can be the same shape and radial size, but at different axial locations and different axial lengths. The space S is located along a length of each axial segment between the twisted blade tips and axial baffles but not at a location of the transverse baffles, while the gaps G are located only between the aligned agitator baffle and respective transverse baffle across an axial thickness of these baffles. Also, the gap G is a constant annular opening defined by the presence of the transverse and agitator baffles, while the space S is not constantly present at all times for the entire length of an axial baffle; it is only functionally present when a blade tip passes closest to an adjacent one of the axial baffles 22.

While not wanting to be bound by theory, it is believed that the spaces S between the outer periphery of the agitator blades and axial baffles create what in effect may be considered a plurality of moving venturis along the length of the mixing chamber. That is, there is believed to be an area of low pressure in the space S such that gas bubbles passing through the space S quickly increase in size while there and then collapse after leaving the space S and entering a higher pressure environment. The twisting and offset of the blades 28 or construction of agitator with blades 28′ is believed to result in the venturis continually moving axially along the length of the axial baffles 22 (e.g., from the leading end of the axial baffles toward the downstream axial end of the axial baffle and then as the agitator rotates, beginning again with the next blade at the leading end of that axial baffle and moving along its length).

The central hub portion 32 of the multibladed agitator extends into the interior of the mixing chamber along the axis X. Those skilled in the art will realize in view of this disclosure that the hub portion may be formed integrally with the shaft, formed separately from the shaft or otherwise omitted. For example, the blades may extend directly from a cylindrical shaft with no hub portion. It should be appreciated that any central hub portion of the agitator is fluid impermeable. In addition, as is apparent from the drawings, the mixing chamber can be, for example, imperforate along its length except for the at least one fluid inlet, the gas inlets and the at least one outlet. This does not exclude providing access openings in the mixing chamber for maintenance. Also, the flowable material travels in general along the axis X from the inlet toward the outlet and during this travel all flowable material in the mixing chamber is forced to pass through the small gaps G. It should be appreciated by one skilled in the art in view of this disclosure that although the material before being inlet into the mixing chamber is referred to as “flowable material,” and the material inside the mixing chamber is also referred to as “the flowable material,” this description is not intended to describe its composition because reactions can occur to the flowable material inside the mixing chamber leading to reacted flowable material that leaves the mixing chamber.

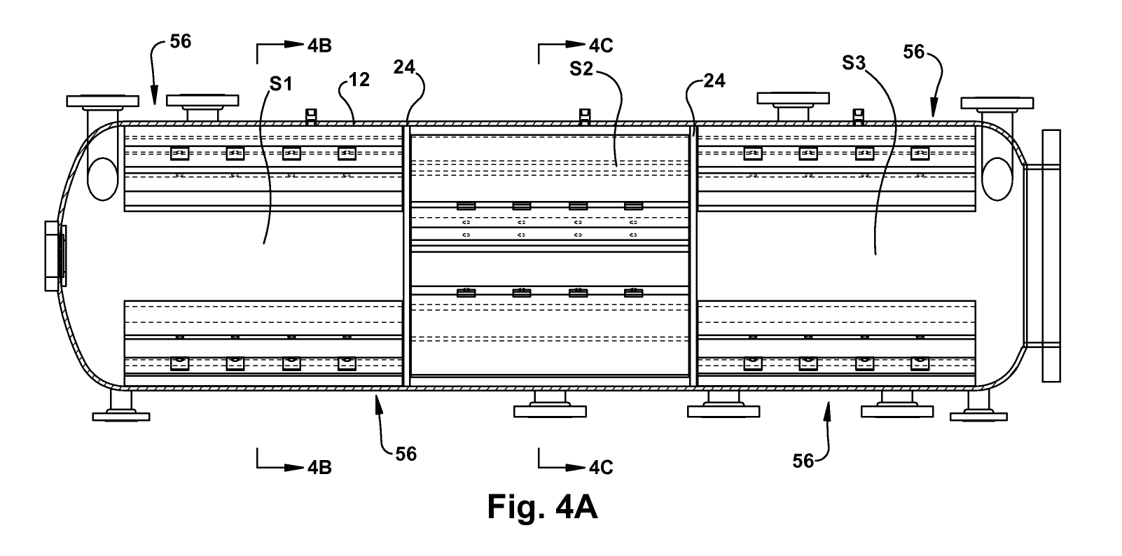

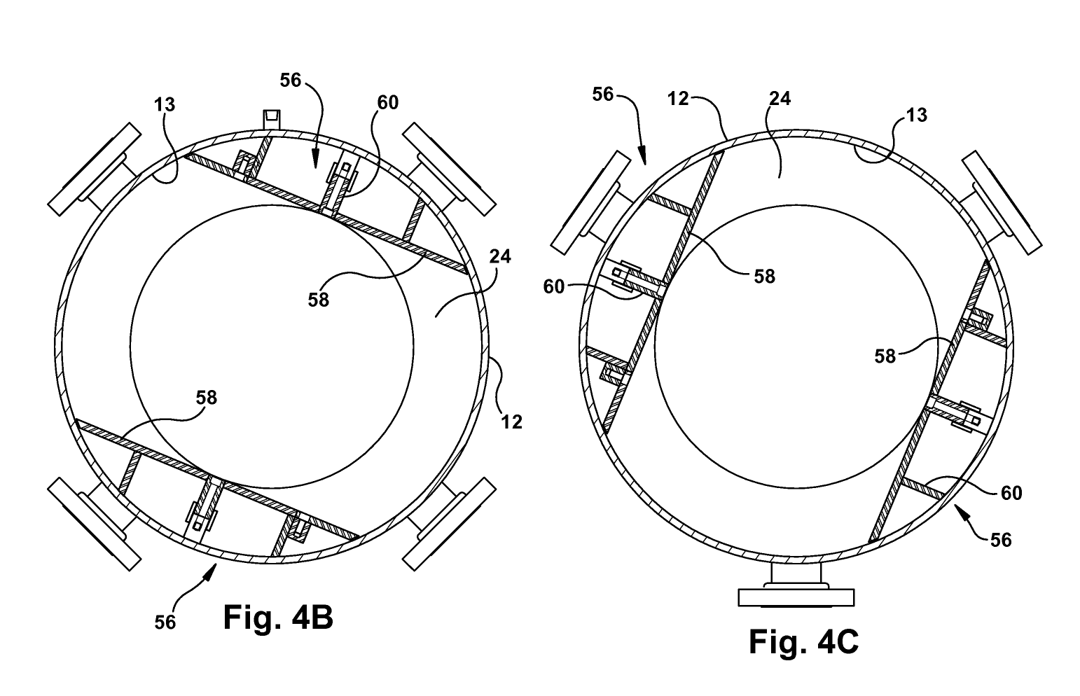

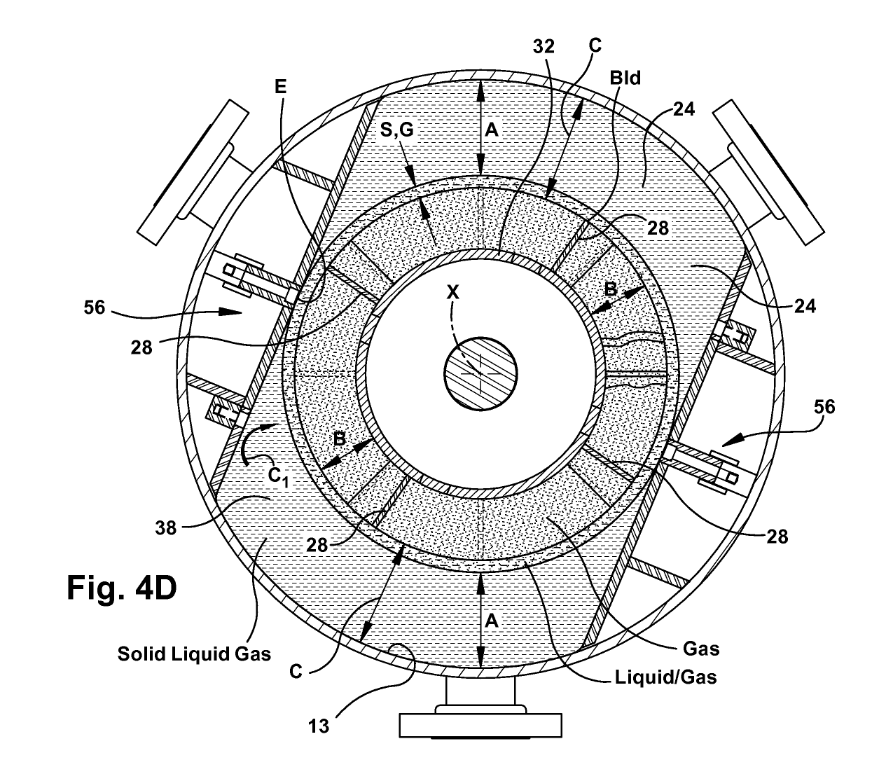

The agitator baffles maintain a fixed position despite rotation of the agitator and their own rotation. This is believed to contribute to the effectiveness of the moving venturis and cavitation inside the mixing chamber by making more gas available in this mechanism. Substantially axial fluid flow of, for example, gas will be inhibited near the agitator and will be directed outwardly by the agitator baffles (e.g., A₂ in FIG. 2A), which is believed to make more gas available for reaction. Substantially axial fluid flow will be inhibited by the transverse baffles which direct the material inwardly (e.g., A₁ in FIG. 2A). Circumferential flow of material is inhibited by the axial baffles (e.g., C₁ in FIG. 4D). Forcing the material (e.g., 43, FIG. 2A) to pass through the small gaps G (e.g., F in FIG. 2A) is also believed to increase residence time and the extent of reaction of material in the mixing chamber.

Referring to FIGS. 1A and 2A, the inlet 16 communicates with the mixing chamber in such a way that the flowable material 38 from the inlet 16 enters the mixing chamber. The inlet 16 is a conduit or pipe that is of sufficient size to admit the desired flow rate of the flowable material. The flowable material 38 may be pumped under pressure at a particular flow rate into the mixing chamber by a pump P1 (FIG. 2A). The mixing apparatus can be designed for flowing the flowable material into the mixing chamber at an upper rate of, for example, 50 gal/min down to a lower rate of at least 5 gal/min.

The flowable material 38 may include a first component 40 and an optional second component 42 (e.g., two liquids or liquid and gas) (FIG. 2A). The first component 40 may be pumped along conduit 41 (represented as a line entering the pump and between the pump and optional venturi V to the mixing chamber) by the pump P while the second component 42 may be pumped along conduit with the pump P2 or not pumped. The venturi V may draw and mix the second component 42 into the first component 40, which forms the first material 38 that is introduced into the mixing chamber through the inlet 16. A third component of the flowable material can be a gas 44 which is directed along a conduit into a header 46 and to conduit 48 leading to each optional gas inlet 20 (FIG. 1A). The gas can travel to gas insert assemblies (FIG. 1F) of the gas inlets 20 as described, for example, in the U.S. Pat. No. 6,036,355 patent and U.S. Pat. No. 5,607,233, which can affect the bubble size and flow rate of the gas. The gas inlets 20 may be positioned at various locations around the mixing chamber. If gas is not used as a component, the second inlets may have a different configuration such as to flow liquid into the mixing chamber; a suitable such configuration would be apparent to those skilled in the art in view of this disclosure and may simply be a conduit connected to the mixing chamber. A gas source containing the gas may be employed and is in fluid communication with the mixing chamber. Conduit, valves, mixing devices and pumps may be used when transporting the components of the flowable material to the mixing chamber as would be appreciated by those skilled in the art. A conduit 50 leads away from the outlet 18 of the mixing chamber. After the mixing and, in particular, reaction of the flowable material in the mixing chamber, the mixed flowable material 52 leaves the mixing chamber via the exit pipe 18 and conduit 50.

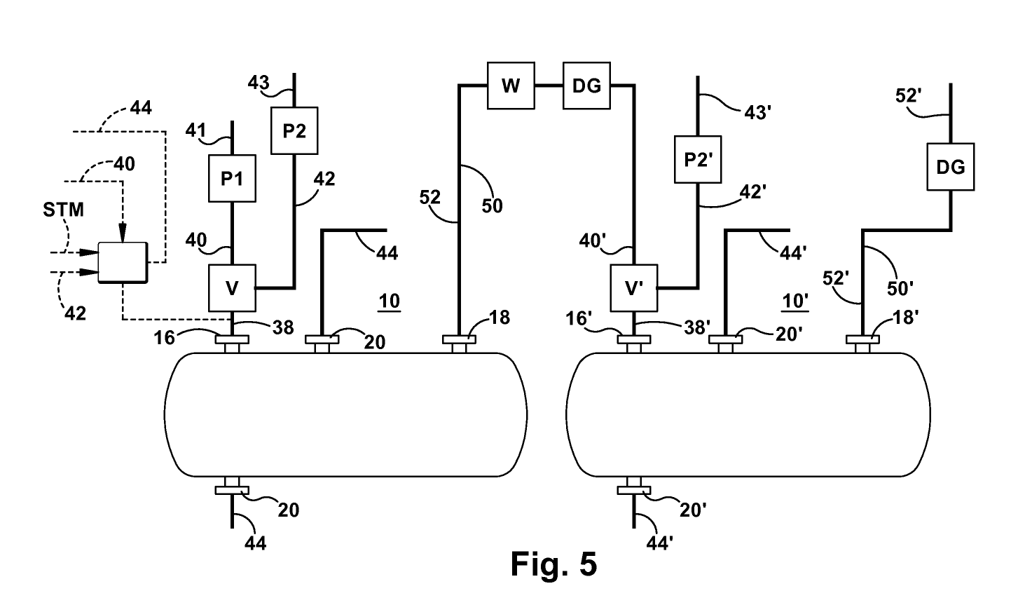

In one aspect, the first component 40, the optional second component 42, the third gas component 44 and a fourth optional steam component Stm may be combined together in a mixer Mx and the mixture then travels along conduit to the inlet 16 of the mixing chamber. This is shown in dotted lines in FIG. 2A and FIG. 5 as it is one version of the flowable material components and how they may be combined together.

The gas component can be mixed with the first component before it is inlet into the mixing chamber, it can separately be directed into the at least one gas inlet 20, or combinations thereof.

Presented are example components of the flowable material, it being understand that many materials may be mixed or mixed and reacted in the present mixing assembly. The first and/or second component of the flowable material is be selected from the group consisting of white liquor, green liquor, black liquor, animal waste, paint and combinations thereof. The third gas component of the flowable material includes a gas selected from the group consisting of O₂, CO₂, O₃, NO, N₂, other inert gas, steam and combinations thereof.

Referring to FIGS. 1A-D, the agitator 26 is driven by a suitable external drive mechanism M and the shaft 30 is coupled to the motor in a manner known to those skilled in the art, for example, a motor driven belt drive (FIG. 1D). The shaft is supported by an appropriate bearing assembly and pillow blocks known in the art. The mixing chamber is supported by suitable supports. The rotating shaft is sealed and supported in the mixing vessel by suitable sealing and bearing devices. The sealing devices are preferably dual-face rotating mechanical seals, although any suitable sealing mechanism may be used.

The unique fluid flow and high reactivity inside the mixing chamber are believed to give rise to areas of intense temperature, which heats the mixing chamber and/or the agitator shaft, and may lead to differences in thermal expansion. Therefore, it is advantageous to design at least one of the seals and bearings, for example, the seal and bearing at the outlet of the mixing assembly, to be movable in response to temperature such as through the use of one or more springs or suitable structure. Those skilled in the art would be able to design a suitable such movable, temperature responsive seal and bearing in accordance with this disclosure.

Referring to FIG. 2A, more specifically, at least two of the transverse baffles 24 and at least two of the agitator baffles 33 are employed. The transverse baffles 24 have, for example, an annular shape and extend perpendicular to the longitudinal axis (FIG. 3D). The transverse baffles 24 include a circular opening 37 in their center. The agitator baffles have a circular outer perimeter 35 and are positioned in alignment with the transverse baffles inside the circular opening forming the gaps G between them. The transverse baffles 24 are fastened to the interior wall 13 of the mixing chamber 12 and, along with the aligned agitator baffles, partition the reactor into three or more axial segments. The transverse baffles 24 disrupt the bulk flow of fluid in substantially the axial direction, substantially lessening the possibility of fluid flowing axially through the chamber undermixed. The transverse baffles 24 force the bulk flow of fluid generally radially inwardly toward the agitator blades 28 to ensure complete mixing, and to form a liquid barrier through which gases cannot pass unobstructed.

The axial baffles 22 of the first design (FIGS. 3A-3D) extend substantially radially inwardly from the interior wall 14 of the mixing chamber and disrupt substantially circumferential material flow within the individual axial segments. As shown in FIGS. 3A and 3B, the axial baffles in one of the segments S1 are offset by an angle theta from the axial baffles in an adjacent one of the segments S2 as viewed in a direction of the axis X (the axial baffles in the downstream segment being shown in dotted lines). Similarly, in FIGS. 3A and 3C, the axial baffles in one of the segments S2 are offset by an angle theta (A) from the axial baffles in an adjacent one of the segments S3 as viewed in a direction of the axis X. The angle theta ranges from about 0 degree to about 180 degrees and, in particular, is not greater than about 90 degrees. The axial baffles 22 extend substantially the entire length of each axial segment. In a given axial segment the axial baffles may be circumferentially spaced apart from each other by a central angle ranging from about 0 degrees to about 180 degrees. The baffles are specifically symmetrically equally spaced around the circumference of the mixing chamber in each segment. For example, when four axial baffles are used in a segment the axial baffles are spaced apart from each other by about 90 degrees.

In one example design that is suitable for oxidizing white liquor, the mixing chamber is about 20 inches in internal diameter and about 6 feet long, for example. Another suitable design has a mixing chamber with an inside diameter of about 5-8 feet and the mixing chamber can be 12-28 feet long.

Referring to FIG. 3D, one version of the blades 28 are advantageously twisted as shown, although other degrees of twist (pitch) and numbers and locations of blades are within the scope of the present disclosure. In particular the blades may extend perpendicular to a tangent to the cylindrical hub portion 32 as the blades twist, throughout the length of the blades. The blades can have a constant height outwards from the hub portion to the peripheral edge or tip, through an entire length of each blade. For example, four blades are disposed on the central portion in each axial segment, each spanning about 90 degrees of the central portion. As shown in FIG. 3D, the blades have a pitch such that the space S is located between each blade tip Bld (when it is adjacent or closest) to edge E along the twist T for the entire length L of the blade as it is rotated past that axial baffle. It should be apparent that due to the blade twist not all blade tip portions are located adjacent the edge E of an axial baffle at the same time. The blade twist T lessens momentary power peaks that a blade parallel to the axis X would be prone to, and it creates a means to either propel the fluid from the mixing chamber or to retard the flow of fluid from the chamber. Thus, when the agitator is operated in accordance with the present disclosure, the twisted blades affect residence time of liquid material within the mixing chamber. The axial length of each agitator blade can be approximately equal to that of each axial baffle. The twisted blades may be used in all aspects of this disclosure including the second axial baffle design.

In the first design (FIGS. 3A-3D) the axial baffles 22 extend substantially parallel to the longitudinal axis X along their length and are exposed to the fluid on both sides of each axial baffle. The length of the first design of axial baffle extends along axis X and the width or height extends radially inwardly and is exposed on two sides to the flowable material.

A variation of the axial baffles of a second design is shown in FIGS. 4A-4D. The axial baffles 56 or baffle assembly of the second design include a plate 58 and support legs 60. The support legs fasten the plate to the interior wall 13 of the mixing chamber. The legs may be welded or otherwise fastened to the interior wall. Here, the width of the plate 58 extends transverse to an orientation from the interior wall radially inward. The plate 58 of one of the baffle assemblies is diametrically opposed from the flat plate of another of the baffle assemblies in that axial segment (e.g., FIG. 4B). Only one side of the plate 58 is contacted with the flowable material inside the mixing chamber. The baffle assemblies of one segment can be offset relative to the baffle assemblies of an adjacent segment (compare FIGS. 4A, 4B to FIGS. 4A, 4C).

Referring to FIG. 4D, while not wanting to be bound by theory there are believed to be three material zones in the mixing chamber as viewed cross-sectionally in a direction of the axis X. A third component may be gas, for example, a reactive gas. A first (and optional second or more) component may be, for example, liquid material or liquid including suspended solids, for example, a liquor solution to be oxidized. Upon rotation of the agitator the centrifugal forces imparted by the blades on the fluid in the mixing chamber are believed to cause primarily liquid and any solid material to reside in an outer zone A located in an annulus radially between the interior wall surface 13 and the inner edges E of the axial baffles. Predominantly gas is believed to be located in an innermost zone B located in an annulus that extends radially outwardly from the central hub portion 32 to the outer edges Bld of the blades. A reaction zone C is believed to be located radially between the outer liquid material zone A and the inner gas zone B and contains a mixture of liquid (or liquid and solid) and gas. The reaction zone C is located in the generally annular space S and gap G all the way to the interior wall 13. Gas will also be disposed in the outer region and some liquid may be disposed in the inner region. All of the flowable material components will be disposed in the gaps G as they must travel through them. The relative proportions of solid, liquid and gas may change along the axial segments of the mixing chamber as more mixing or mixing and reaction occurs as the material travels along the length of the mixing chamber toward the outlet.

The size of the reaction zone C can produce a particular relatively short residence time of liquid material in the mixing chamber. When the size of the reaction zone C is increased, the liquid material will have a longer residence time in the mixing chamber. When the size of the reaction zone C is decreased, the liquid material will have a shorter residence time in the mixing chamber. Moreover, the gaps G lengthen the time the fluid and gas spend in the mixing chamber and avoid unreacted oxygen in the gas. In addition, the size of the space S can affect the extent by which cavitation occurs inside the mixing chamber. Referring to FIGS. 3D and 4D, one can see that the entire volume of fluid that is continuously being fed into the mixing chamber will pass through the relatively small gaps G. In addition, fluid and gas inside the mixing chamber travels through the spaces S between the outer peripheral edges of the agitator blades and the axial baffles.

The relative sizes of the zones A, B and C may be adjusted mechanically or operationally. Their sizes and locations are only shown for purposes of illustration in FIG. 4D). One should appreciate the zones A, B and C would be present in similar locations in FIG. 3D which employs the first design of the axial baffles. The size of the space S and gap G may be determined when the reactor mixer is designed, by adjusting the size or height of the blades and the width of the axial baffles of the first design (or inward location of the axial baffle plate in the second axial baffle design) as well as the inside diameter of the mixing chamber.

The drive M can rotate the agitator clockwise or counterclockwise. The drive is preferably a variable speed drive that can be operated to rotate the agitator slowly or quickly. Those skilled in the art will appreciate in view of this disclosure that the relative values of “fast” or “slow” rotational speed of the agitator and the effect these values and rotational direction have on liquid residence time in the reaction zone, can be empirically determined for each first component, second component, etc. fluid system.

In operation, a first component, for example, a white liquor solution to be oxidized, is directed through the inlet 16 at a certain flow rate into the mixing chamber. The gas, for example, oxygen-containing gas, is directed along headers, through the gas inlets into the mixing chamber. The agitator rotates at a particular speed and direction depending upon the desired residence time of material in the reactor mixer. The residence time can also adjusted by selecting the size of the annular space S in view of the inside diameter of the mixing chamber and heights of each of the blades and axial baffles. Fluid flow is disrupted generally circumferentially in the mixing chamber by the axial baffles. Fluid flow is disrupted in a general direction of the axis by the transverse baffles and agitator baffles. In particular, gas flow can be disrupted along the axial direction adjacent to the agitator by the transverse agitator baffles. All of the flowable material inside the reactor is forced to pass through the gaps G. The mixed (and reacted) material (e.g., oxidized white liquor) leaves the mixing chamber through the outlet.

The operating parameters of the system vary according to the dimensions and end use of the system, as well as many other factors. For purposes of illustration only, the mixing system can process from 0.1 to 500 gallons per minute of a pulp mill liquor converting the liquor to an oxidized liquor useful within pulp mill operations. The mixing assembly may even be designed to process up to 1000 gallons per minute of material. The mixing chamber is capable of containing pressures up to 250 pounds per square inch gauge, for example. The blade speed depends upon the geometry of the agitator and the degree of mixing required.

The white liquor solution and the oxygen-containing gas are intensively mixed in the pressurized high intensity mixing assembly, and the through put rates of the white liquor and the oxygen-containing gas are such that the exothermic heat of reaction can be sufficient to autocatalyze the oxidation reaction. The reaction in the mixing assembly is almost instantaneous and requires a very short residence time in the present mixing assembly.

The mixing assembly should be capable of high intensity mixing of the oxygen-containing gas and the white liquor such that it promotes a chemical reaction between sodium sulfide and oxygen. Accordingly, it will have a high through-put rate dictating a short residence time, an optional means for producing small oxygen gas bubbles (e.g., insert assemblies of the U.S. Pat. No. 6,036,355 patent) and a means for intensively mixing the gas and liquid.

The mixing assembly is adapted to mix components under pressure. More specifically, high intensity mixing assembly is provided for violently mixing a solution containing white liquor with an oxygen-containing gas under a pressure greater than atmospheric pressure.

When pumped into the mixing chamber, the white liquor solution may be at its normal process temperature of, for example, about 60 degrees C. to about 100 degrees C., this temperature being the temperature of the white liquor as received from a paper pulping mill. A continuous stream of an oxygen-containing gas is provided to the mixing chamber. Oxygen flow rates may range, for example, from about 0.1 standard cubic feet per minute (“scfm”) to about 10 scfm per gallon per minute (“gpm”) of solution entering the mixing chamber, for example, and in particular, oxygen flow rates may range from about 0.1 scfm to about 5 scfm.

The pressure of the oxygen-containing gas may range from atmospheric pressure to about 350 pounds per square inch gauge (“psig”), for example. In particular, the pressure of the oxygen-containing gas may range from about 50 to about 350 psig and from about 50 to about 200 psig. Oxygen, of the oxygen-containing gas, reacts with and oxidizes the reducing compounds of the white liquor. The oxygen-containing gas may have a composition, for example, of 90-94% O₂, with the balance being inert gas, all the way up to 100% O₂. An amount of CO₂ that is added can be that which is sufficient for pH control to a desired level. Heat from an external heat source can be added to the system to speed up the reaction (e.g., using steam or hot liquid). The white liquor oxidation reaction as described here is exothermic. As such, no external heat is required to be supplied to the mixing chamber as the oxidation reaction proceeds. No heat from an external heat source needs to be added to the system to speed up the white liquor oxidation reaction. The heat that increases the reaction rate is produced chemically as a result of the exothermic oxidation reaction of the reducing compounds of the white liquor and the oxygen of the oxygen-containing gas, and to a lessor extent by friction developed by the operating components of the reactor and by the viscosity of the moving material contained therein. Exit temperatures of the oxidized white liquor can range from about 100 degrees C. to about 200 degrees C., for example.

The aforementioned operating conditions result in reduced residence times of the white liquor solution in the mixing assembly. Residence times not more than 2 minutes in the mixing assembly are possible. It will be appreciated that the residence time of the flowable material (e.g., white liquor) may vary depending on the volume of the reactor and the inlet flow of white liquor solution into the mixing chamber (and rotation direction of the agitator). In all aspects of the disclosure, the mixed flowable material that leaves the mixing assembly may be optionally degassed. An entire process from combination/mixing of the flowable material components, inlet of the components into the mixing chamber, residence time of the flowable material in the mixing chamber, outlet of the material from the mixing chamber and degassing, can occur in not more than 10 minutes.

The white liquor may be oxidized so as to contain Na₂S in an amount less than 1 g/l and in particular in trace amounts.

The present disclosure thus provides a continuous flow-through process for the oxidation of white liquor to form an oxidized white liquor solution containing sodium sulfate as its primary constituent. The present disclosure may also be used to oxidize a “black liquor” solution. It is believed that the increased production rates of the present disclosure are realized by a faster, more efficient oxygen absorption into the liquid reaction mixture, be it white liquor, black liquor or other liquid reactants known in the art.

Another aspect of this disclosure is to construct and arrange two mixing assemblies in series as shown in FIG. 5. The components of the second mixing assembly are the same or similar to those of the first assembly of FIGS. 1-4 with like parts receiving like reference numerals throughout the views. This permits a first reaction to be carried out in the first mixing assembly 10 and a second or further reaction to be carried out in the second mixing assembly 10′. Optional further flowable material including the oxygen containing gas 42′ may be fed into the fluid mixture 52 leaving the first mixing assembly 10, as part of the flowable material 38′ entering the second mixing assembly 10′. In addition, optional steps may take place between the mixing assemblies including separating and washing represented schematically by W and degassing represented by DG, before passing the material mixture from the first mixing assembly 10 into the second mixing assembly 10′ as flowable material 38′. An optional venturi V′ may be used to add further components of the flowable material.

Many modifications and variations of the disclosed embodiments will be apparent to those of ordinary skill in the art in light of the foregoing disclosure. Therefore, it is to be understood that, within the scope of the appended claims, the invention can be practiced otherwise than has been specifically shown and described.

What is claimed is:

1. A continuous dynamic mixing assembly, comprising:
a mixing chamber having an interior wall which is substantially symmetrical about a central longitudinal axis;
at least one inlet for introducing flowable material into said mixing chamber;
axial baffles connected to the interior wall and extending along said axis along a length of said axial baffles, which disrupt substantially circumferential fluid flow in said mixing chamber;
transverse baffles extending from the interior wall transverse to said axis along a major dimension of said transverse baffles; and
a rotatable agitator including agitator baffles extending transverse to said axis at locations in alignment with respective said transverse baffles, forming gaps between said agitator baffles and said respective transverse baffles;
wherein said transverse baffles and said agitator baffles are adapted to disrupt substantially axial fluid flow in said mixing chamber while forcing said flowable material to flow through said gaps; and
at least one outlet for discharging mixed said flowable material from said mixing chamber.

2. The mixing assembly of claim 1 said at least one inlet including at least one second inlet for introducing a component of said flowable material into said mixing chamber.

3. The mixing assembly of claim 1 wherein said at least one inlet is constructed and arranged to introduce said flowable material tangentially into said mixing chamber.

4. The mixing assembly of claim 1 wherein said at least one outlet is constructed and arranged to permit said flowable material to travel tangentially out of said mixing chamber.

5. The mixing assembly of claim 1 comprising a venturi upstream of said at least one inlet for mixing a second component of said flowable material into a first component of said flowable material before passing through said at least one inlet into said mixing chamber.

6. The mixing assembly of claim 1 wherein said agitator includes a central shaft, a cylindrical central portion fastened to and extending around said shaft and blades are twisted along said central portion.

7. The mixing assembly of claim 1 wherein said agitator includes flat faces and straight blades extending diagonally along said flat faces in a direction of a length of said agitator, said blades having arcuate portions.

8. The mixing assembly of claim 1 wherein said transverse baffles and said agitator baffles partition said mixing chamber into at least three axial segments, and each of said segments includes multiple blades extending from said agitator and at least two of said axial baffles.

9. The mixing assembly of claim 1 wherein said axial baffles extend from the interior wall of said mixing chamber inwardly toward said agitator and are adapted to be contacted by said flowable material on two sides of each of said axial baffles.

10. The mixing assembly of claim 1 wherein each of said axial baffles includes a baffle assembly having a plate and support legs, wherein said support legs fasten said plate to the interior wall of said mixing chamber, said plate being adapted to be contacted by said material only on one side of said plate.

11. The mixing assembly of claim 1 wherein each of said agitator baffles has a substantially circular outer peripheral edge and each of said transverse baffles is annular and includes a substantially circular inner peripheral opening in which a respective one of said agitator baffles is disposed, wherein said gaps are substantially annular.

12. The mixing assembly of claim 2 comprising a source of oxygen-containing gas as a component of said flowable material, said source being connected to said at least one second inlet.

13. A method of mixing flowable material in a continuous dynamic mixing assembly, comprising:
providing a mixing chamber having an interior wall which is substantially symmetrical about a central longitudinal axis;
providing at least one inlet into said mixing chamber;
providing axial baffles connected to the interior wall and extending along said axis along a length of said axial baffles;
providing transverse baffles connected to the interior wall and extending from the interior wall transverse to said axis along a major dimension of said transverse baffles;
providing a rotatable agitator including agitator baffles extending transverse to said axis, said agitator baffles being disposed in alignment with respective said transverse baffles, forming gaps between said agitator baffles and said respective transverse baffles;
providing at least one outlet from said mixing chamber;
directing flowable material through said at least one inlet into said mixing chamber;
rotating said agitator inside said mixing chamber and mixing said flowable material;
disrupting substantially circumferential fluid flow in said mixing chamber with said axial baffles;
disrupting substantially axial fluid flow with said transverse baffles and said agitator baffles;
forcing said flowable material inside said mixing chamber to travel through said gaps between said transverse baffles and said agitator baffles; and
removing mixed said flowable material from said mixing chamber though the at least one said outlet.

14. The method of claim 13 wherein said flowable material includes a component selected from the group consisting of white liquor, green liquor, black liquor, paint, animal waste and combinations thereof and a gas component selected from the group consisting of O₂, CO₂, O₃, NO, N₂, other inert gas, steam and combinations thereof.

15. The method according to claim 13 wherein said flowable material includes a gas component.

16. The method of claim 15 wherein said gas component is selected from the group consisting of O₂, CO₂, O₃, NO, N₂, other inert gas, steam and combinations thereof.

17. The method according to claim 13 comprising providing a motor to drive said agitator, wherein horsepower/volume of said mixing assembly is at least 4/1, where horsepower is the power at which the motor is rated and volume is a volume of said flowable material in said mixing chamber in gallons.

18. The method of claim 13 wherein rotating speed of said agitator is at least 60 rpm.

19. The method of claim 13 wherein said flowable material continuously enters said mixing chamber at a rate of at least 5 gpm.

20. The method of claim 13 wherein a residence time of said flowable material in said mixing chamber is less than 2 minutes.

21. The method of claim 13 comprising degassing said mixed flowable material that leaves said mixing chamber.

22. The method of claim 14 wherein said flowable material includes said white liquor and said gas includes O₂, comprising oxidizing said white liquor with said gas inside said mixing chamber.

23. The method of claim 13 wherein said agitator includes blades that are twisted along said axis.

24. The method of claim 13 comprising providing two of said mixing assemblies in series and passing said mixed flowable material from the at least one outlet of a first of said mixing assembly to the at least one inlet of a second of said mixing assemblies, said flowable material including a liquid component and a gas component.

25. The method of claim 24 comprising carrying out reactions of said flowable material inside said first and second mixing assemblies.
